(19) United States
(12) Patent Application Publication
(10) Pub. No.: US 2024/0413590 A1
(43) Pub. Date: Dec. 12, 2024

(54) BACKPLANE CONNECTORS WITH SHIELDED TERMINALS

(71) Applicant: Molex, LLC, Lisle, IL (US)

(72) Inventors: Timothy K. Ibarra, Conway, AR (US); Timothy S. Elo, Naperville, IL (US); Michael D. Rost, Taipei City (TW); John C. Laurx, Aurora, IL (US); William J. Miller, II, New Lenox, IL (US); Jose J. Gonzalez, Jr., Joliet, IL (US); Joel Kwasny, Plainfield, IL (US); Scott Edwards, Little Rock, AR (US); Yilin Sung, New Taipei City (TW); Jerber Mendoza, Aurora, IL (US); Marc E. Krause, Darien, IL (US)

(21) Appl. No.: 18/273,988

(22) PCT Filed: Jan. 28, 2022
(86) PCT No.: PCT/IB2022/050772

§ 371 Date: Jul. 25, 2023

Related U.S. Application Data
(60) Provisional application No. 63/143,658, filed on Jan. 29, 2021.

(51) Int. Cl. H01R 13/6587; H01R 12/73

(52) U.S. Cl. CPC H01R 13/6587; H01R 12/737

(57) ABSTRACT

Backplane connector systems include electromagnetic shielding terminal enclosures to protect high-speed, differential data signals from deleterious electromagnetic signals. Such terminal enclosures include connected, U-shaped shields that include protrusions that slidably contact one another to form a plurality of electrical ground paths. The plurality of paths direct such deleterious signals away from the high-speed, differential data signals.

### CROSS-REFERENCE TO RELATED APPLICATION

This application claims priority to U.S. Provisional Application No. 63/143,658 filed Jan. 29, 2021, which is incorporated herein by reference in its entirety.

### TECHNICAL FIELD

This disclosure relates to the field of connectors, more specifically to high-speed data connectors.

### INTRODUCTION

Backplane connectors used in a number of different applications are designed to provide certain features, such as the ability to support high-speed data rates.

Some backplane connectors may be configured in an orthogonal configuration (e.g., a configuration that includes two electronic circuit boards that are positioned orthogonal to one another). The orthogonal configuration allows for a bottom, main circuit board and a number of secondary circuit boards (often referred to as daughter cards) that are positioned orthogonal to the main circuit board but parallel to each other. Each daughter card may support one or more integrated circuits (IC) that provide a desired processing functionality.

One issue with backplane connectors is the amount of electrical crosstalk between adjacent pairs of high-speed, differential data signals. Existing techniques to reduce crosstalk have been inadequate.

Accordingly, there is a need for backplane connectors that reliably support high-speed data rates with minimal crosstalk.

### SUMMARY

In an embodiment, an exemplary backplane connector system may comprise; a first orthogonally positioned connector assembly comprising a first housing and a first wafer set, wherein the first wafer set comprises one or more first wafers and each first wafer comprises one or more first U-shaped shields, each first shield configured as a first part of an electromagnetic shielded terminal enclosure to protect high-speed differential data signals (e.g., signals at least up to 112 Gigabits per second (Gbps)) from deleterious electromagnetic signals; and a second orthogonally positioned connector assembly comprising a second housing configured to connect to the first housing, and a second wafer set, wherein the second wafer set comprises one or more second wafers and each second wafer comprises an electrically grounded plane comprising one or more integral, second U-shaped shields, each second shield configured as a second part of the electromagnetic shielded terminal enclosure to protect the high-speed differential data signals from deleterious electromagnetic signals.

The first assembly may further comprise an electrical ground insert connected to each of the one or more first U-shaped shields of each first wafer to form an electrical ground path at each connection.

In embodiments, each of the one or more first U-shaped shields of each first wafer may comprise opposing sidewalls, where each opposing sidewall may comprise at least one first protrusion. Further, each first protrusion may be configured to slidably contact one or more second protrusions from one of the one or more second U-shaped shields to form the electromagnetic shielded terminal enclosure and to form an electrical ground path that includes the first protrusion and the one or more second protrusions.

Each of the one or more first wafers may be configured offset from a neighboring wafer within the first wafer set to reduce the effects of unwanted, deleterious electromagnetic signals (e.g., crosstalk).

The second housing may further comprise a support structure to support and align at least the electromagnetic shielded terminal enclosure. Such a support structure may comprise one or more openings, one or more separating ribs and one or more tower foundations. In embodiments. (i) one of the one or more openings may be configured to receive a set of shields comprising one of the one or more first U-shaped shields and one of the one or more second U-shaped shields, (ii) one of the one or more foundations may support the set of shields, and/or (iii) one of the one or more ribs may be configured to maintain the alignment of, and separation of, the set of shields.

Still further, each of the first U-shaped shields may comprise a first terminal support structure each of the second U-shaped shields may comprise a second terminal support structure. In embodiments, the first terminal support structure may be configured at a position within a respective first U-shaped shield to function as a fulcrum to support an end of a respective terminal of the first wafer set while, similarly, the second terminal support structure may be configured at a position within a respective second U-shaped shield to function as a fulcrum to support an end of a respective terminal of the second wafer set.

Each of the one or more second U-shaped shields may comprise opposing sidewalls, where each sidewall may comprise one or more second protrusions configured to slidably contact one or more first protrusions of one of the one or more first U-shaped shields to form an electromagnetic shielded terminal enclosure and to form an electrical ground path that includes the first and second protrusions.

Still further, each of the one or more second U-shaped shields may comprise one or more integral, grounding wings, where each wing may be configured to contact one of the first U-shaped shields to form an electrical ground path. Accordingly, by having second U-shaped shields with multiple contact wings that may contact multiple first U-shaped shields, a highly redundant grounding structure may be established with throughout the systems.

Each of the one or more second U-shaped shields may additionally comprise an extension connected to an electrical ground cover to form an electrical ground path between the shield and the cover.

In addition to the embodiments just described, another exemplary backplane connector system may comprise: a first orthogonally positioned connector assembly comprising a first housing and a first wafer set, wherein the first wafer set comprises one or more first wafers and each first wafer comprises one or more first U-shaped shields, each first shield configured as a first part of an electromagnetic shielded terminal enclosure to protect high-speed differential data signals from deleterious electromagnetic signals; and a second orthogonally positioned connector assembly comprising a second housing configured to connect to the first housing to provide a plurality of electrical ground paths between the first and second assemblies, and a second wafer set, wherein the second wafer set comprises one or more second wafers and each second wafer comprises an electrically grounded plane comprising one or more integral, second U-shaped shields, each second shield configured as a second part of the electromagnetic shielded terminal enclosure to protect high-speed differential data signals from deleterious electromagnetic signals.

In such an embodiment each of the one or more first U-shaped shields of each first wafer may comprise opposing sidewalls, where each opposing sidewall may comprise at least one first protrusion. Each such protrusion may be configured to slidably contact one or more second protrusions from one of the one or more second U-shaped shields to form the electromagnetic shielded terminal enclosure and to form at least one of the ground paths that includes the first and second protrusions. Further, each of the one or more second U-shaped shields may comprise one or more integral, grounding wings, where each wing may be configured to contact one of the first U-shaped shields to form at least a second one of the ground paths.

Yet another exemplary backplane connector system may comprise a pattern of offset, electromagnetic shielded terminal enclosures, where each terminal enclosure is configured as a set of electromagnetic U-shaped shields that form one or more electrical ground paths and wherein each terminal enclosure is not aligned next to a neighboring terminal enclosure formed by another set of electromagnetic, U-shaped shields.

### BRIEF DESCRIPTION OF THE DRAWINGS

The present disclosure is illustrated by way of example and not limited to the accompanying figures in which like reference numerals may refer to similar elements and in which:

FIG. 1 illustrates a view of an exemplary backplane connector system that includes two connected assemblies;

FIG. 2 illustrates the same backplane connector system as in FIG. 1 but with the assemblies disconnected;

FIG. 3 illustrates another view of the disconnected assemblies in FIG. 2;

FIG. 4 illustrates an exploded view of one of the assemblies in the previous figures;

FIG. 5 illustrates another exploded view of one of the assemblies in the previous figures;

FIG. 6 is an enlarged view of exemplary U-shaped, electromagnetic shields that may be used to form first parts of an electromagnetic shielded terminal enclosure structure that shields conductive terminals that are transporting high-speed, differential data signals (hereafter an electromagnetic shielded terminal enclosure may be referred to as a “terminal enclosure” or “cage”);

FIG. 7 illustrates a view of offset terminals of a connector assembly;

FIG. 8 illustrates a simplified view of an exemplary wafer;

FIG. 8A illustrates an enlarged view of the embodiment depicted in FIG. 8;

FIG. 9 illustrates an exploded view of a second assembly;

FIG. 10 illustrates another exploded view of the assembly in FIG. 9;

FIG. 11 illustrates a plurality of second U-shaped shields that form second parts of exemplary terminal enclosures;

FIG. 12 illustrates an enlarged view of some second U-shaped shields that form second parts of exemplary terminal enclosures;

FIG. 13 illustrates a view of an exemplary connection of the first and second U-shaped shields;

FIG. 14 illustrates an enlarged view of the exemplary connection of first and second U-shaped shields that form a terminal enclosure;

FIG. 15 illustrates a pattern of offset, terminal enclosures that form one or more electrical ground paths;

FIG. 16 illustrates an enlarged view of a pattern of offset, terminal enclosures that form one or more electrical ground paths;

FIG. 17 illustrates a view of a partial connector assembly with wafers removed so as to appreciate wafers can be configured to form offset, terminal enclosures;

FIG. 18 illustrates a view of a wafer that can be used in the embodiment depicted in FIG. 17;

FIG. 18A illustrates a simplified view of a section taken along the line 18-18 in FIG. 18.

FIG. 19 illustrates an enlarged view of the connection of second U-shaped electromagnetic shields to an electrically grounded cover;

FIG. 20 depicts an exploded view of a wafer;

FIG. 21 depicts another partially exploded view of a wafer where a electrically grounded cover is separated from the wafer;

FIG. 22 depicts an exemplary electrically grounded plane of a wafer;

FIG. 23 depicts a view of a wafer without an electrically grounded plane attached;

FIG. 24 depicts the connection of offset wafers to an offset tail alignment structure;

FIG. 25 depicts another view of an offset tail alignment structure;

FIG. 26 depicts yet another view of the connection of offset wafers to an offset tail alignment structure;

FIG. 27 depicts an enlarged view of the connection of offset wafers to an offset tail alignment structure;

FIG. 28 depicts a view of an exemplary wafer gripper;

FIG. 29 depicts an enlarged view of a terminal enclosure supported by a housing of one of the assemblies of an exemplary system;

FIG. 30 depicts a side view of a terminal enclosure that includes exemplary terminal support structures;

FIG. 31 depicts an exemplary opening to receive an exemplary terminal support structure;

FIG. 32 depicts a partial view of an exemplary first connector mating with an exemplary second connector;

FIG. 33 depicts another view of the mating interface between an exemplary first connector and an exemplary second connector;

FIG. 34 depicts a view of a simplified section of a first connector, illustrating how a wafer shield can engage an insert;

FIG. 35 depicts another view of a simplified section of a first connector with the wafer shield and the frame omitted; and

FIG. 36 depicts an enlarged sectional view of a first shield engaging an insert.

### DETAILED DESCRIPTION, INCLUDING EXEMPLARY EMBODIMENTS

Simplicity and clarity in both illustration and description are sought to effectively enable a person of skill in the art to make, use, and best practice embodiments disclosed herein in view of what is already known in the art. One skilled in the art will appreciate that various modifications and changes may be made to the specific embodiments described herein without departing from the spirit and scope of the disclosure. Thus, the specification and drawings are to be regarded as illustrative and exemplary rather than restrictive or all-encompassing, and all such modifications to the specific embodiments described herein are intended to be included within the scope of the disclosure. Yet further, unless otherwise noted, features disclosed herein may be combined together to form additional combinations that were not otherwise described or shown for the sake of brevity.

It should also be noted that one or more exemplary embodiments may be described or illustrated as a method or process. Although a method or process may be described as an exemplary sequence, unless otherwise noted the steps in the sequence may also be performed in parallel, concurrently or simultaneously. In addition, the order of each formative step within a method or process may be re-arranged. A described or illustrated method or process may be terminated when completed, and may also include additional steps that are not described or illustrated herein if, for example, such steps are known by those skilled in the art.

As used herein the terms “high-speed”, “high-speed data” and “high-data rate” may be used interchangeably. As used herein, the term “embodiment” or “exemplary” mean an example that falls within the scope of the disclosure.

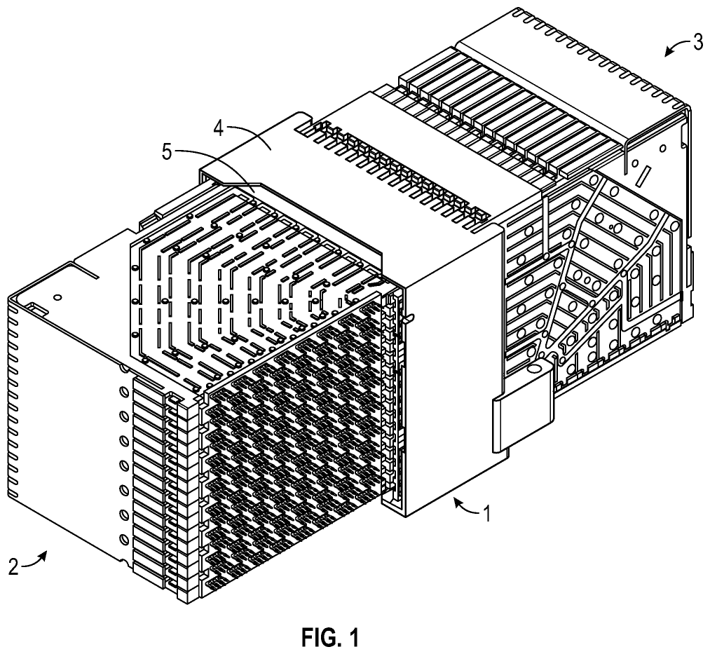

Referring now to FIG. 1 there is depicted a view of an exemplary connector system 1, typically used in a backplane application. As shown, connector assembly 1 may include connector assemblies 2, 3 that are shown connected together to form the connector system 1. Also shown in FIG. 1 is a first housing 4 of connector assembly 3 overlappingly connected to a second housing 5 of connector assembly 2, it being understood that each connector assembly 2, 3 includes at least one housing (as used herein the nomenclature “first” and “second” are used to distinguish between two distinct components, one in each assembly 2,3). Though not shown in FIG. 1, each connector assembly 2, 3 may be connected to one a substrate such as a circuit board.

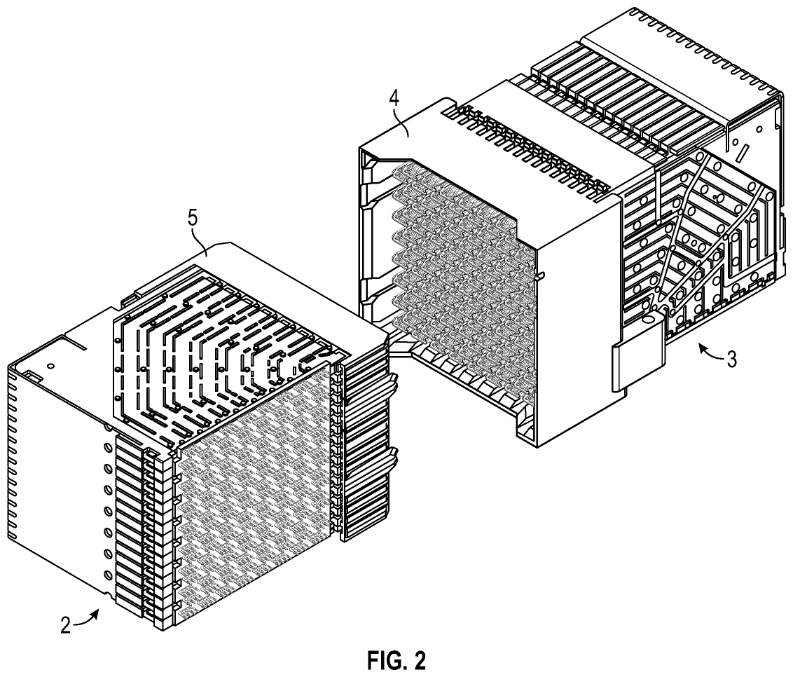

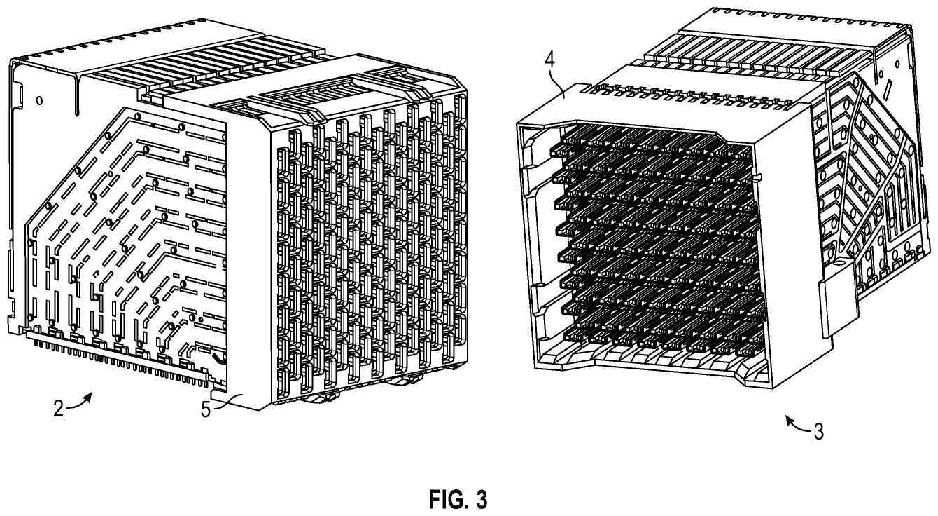

FIGS. 2 and 3 illustrate the same connector system 1 but with the connector assemblies 2, 3 not mated together.

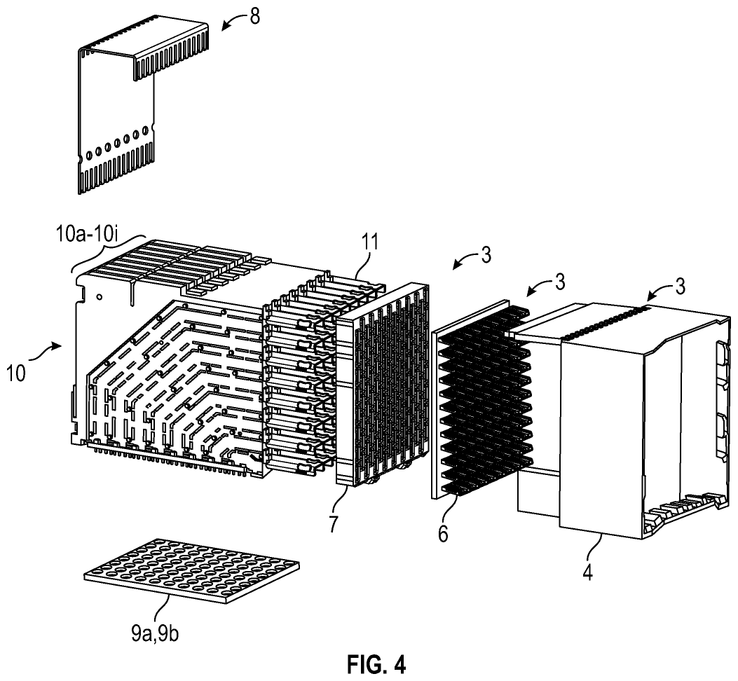

Referring now to FIG. 4 there is illustrated an exploded view of the first connector assembly 3 (hereafter “first” connector assembly or just “first assembly” to distinguish it from “second” connector assembly 2). As shown, first connector assembly 3 may comprise, among other components, a first housing 4, shield support structure 6, insert 7, retaining member 8, first tail alignment structures 9a, 9b and a wafer set 10 (which could be a first wafer set if multiple wafer sets were to be discussed). In embodiments, the wafer set 10 may include a plurality of wafers 10a to 10i (where “i” indicates a last wafer and the wafers could be considered first wafers if multiple wafer sets were being discussed) that may be aligned and supported by retaining member 8.

In embodiments, each wafer of the wafer set 10 may support one or more pairs of terminals that transmit and receive high-speed, differential data signals (e.g., at least up to 112 Gbps). Terminals may be electromagnetically shielded as described more fully herein by first shields 11 that may be configured as a first part of an terminal enclosure that helps provide shielding for the mating interface. In embodiments, the terminals and shields 11 may be structurally supported by support structure 6.

Further, in an embodiment the insert 7 may be formed of a plastic that is conductively plated along traces that provide a desired connection or along substantially all of it surface so that it may be connected to each of the one or more first shields 11 of each first wafer 10a to 10i to form an electrical ground path at each connection that includes the shields 11 and insert 7. Alternatively insert 7 may be configured as a conductive cap composed of a stamped sheet metal.

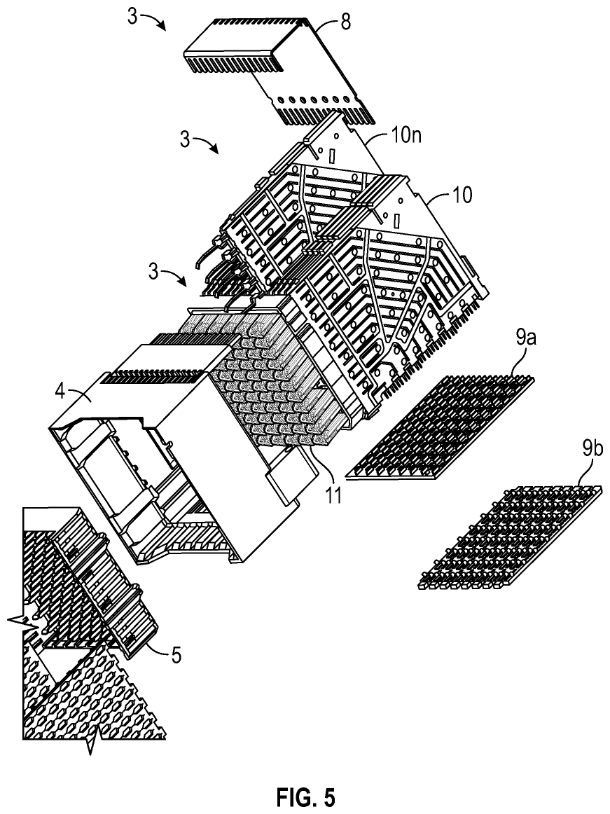

FIG. 5 illustrates another exploded view of the assembly 3. In this view one first wafer 10n of the plurality of first wafers 10a to 10i is illustrated as being inserted into the wafer set 10 (where “n” refers to one exemplary wafers within wafer set 10).

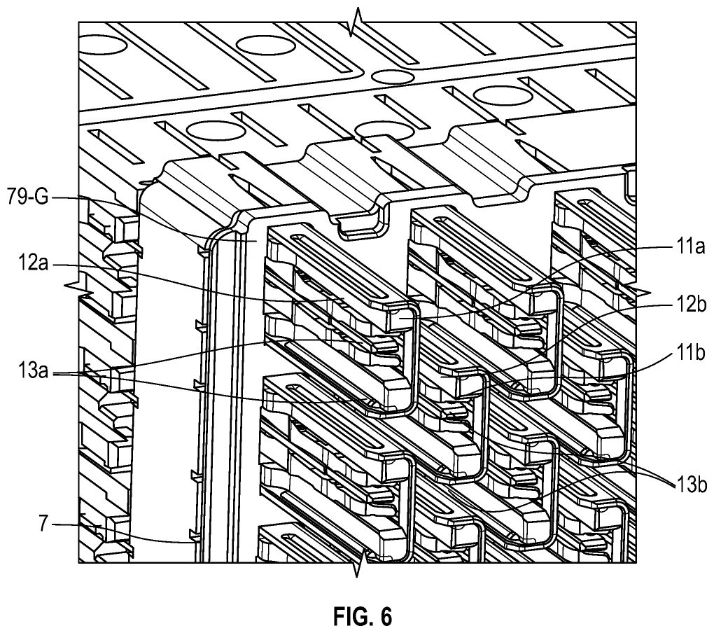

FIG. 6 is an enlarged view of ground insert 7 connected to exemplary, first shields 11a, 11b, 11n that may be used to form first parts of terminal enclosures (“n” refers to one of the shields). As depicted, the shields 11 a, 11b, 11nm are U-shaped. As shown, each first shield 11a, 11b, 11n may be connected to the insert 7 at one or more points, such as points 7a, to form an electrical ground path (denoted “G”) where a conductive path is provided on the insert. It should be noted that each connection point between the insert 7 and a shield may form a ground path though only a few such points are illustratively labeled in FIG. 6. Further, while only four shields are shown in FIG. 6 this is merely exemplary. More or fewer shields may be connected to an insert 7 (typically more than four shields will be provided).

Each first shield 11a. 11b may support fingers 13a,13b for receiving a set of contacts that are transmitting and receiving differential, high-speed data signals.

In embodiments, each of the one or more first shields of each first wafer 10a to 10i may include respective first protrusions 12a, 12b on opposing shield sidewalls. As depicted, each shield includes two opposing sidewalls, each opposing sidewall including at least one protrusion 12a, 12b respectively (though only protrusions are shown on one opposing sidewall of each shield in FIG. 6).

As noted previously each of the first U-shaped, electromagnetic shields 11 may be configured as a first part of a terminal enclosure (e.g., a top, bottom or one side depending on the orientation of the terminal enclosure). In embodiments, each protrusion 12a, 12b of each first shield may be configured to slidably contact one or more protrusions from mating shield of connector assembly 2 that may be configured as “second” parts of the same terminal enclosure (e.g., a bottom, top or second side of the same terminal enclosure) to form at least one electrical ground path therebetween. Said another way, first shields 11 and their respective protrusions 12 may form one part of a terminal enclosure that reduces the deleterious effects from unwanted electromagnetic signals or interference on high-speed, differential data signals being transported by terminals within each cage.

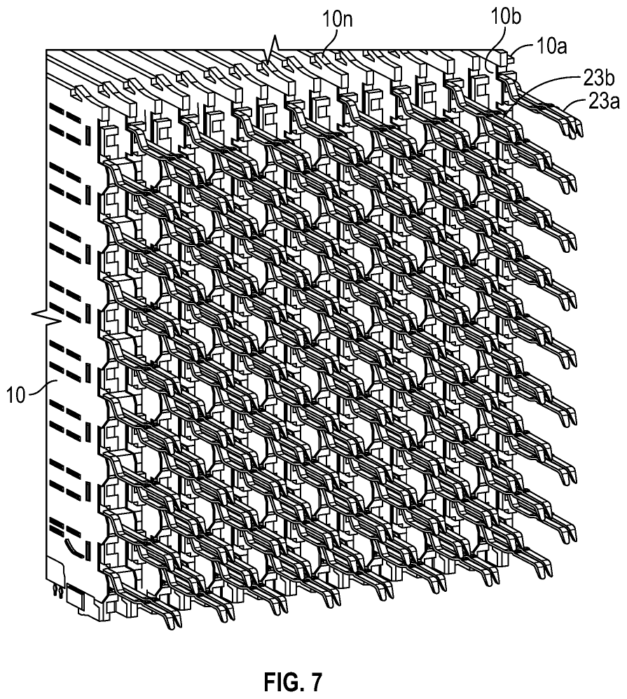

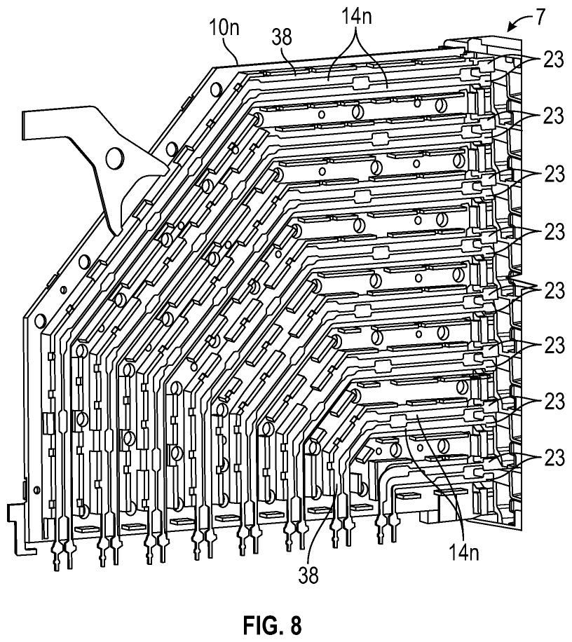

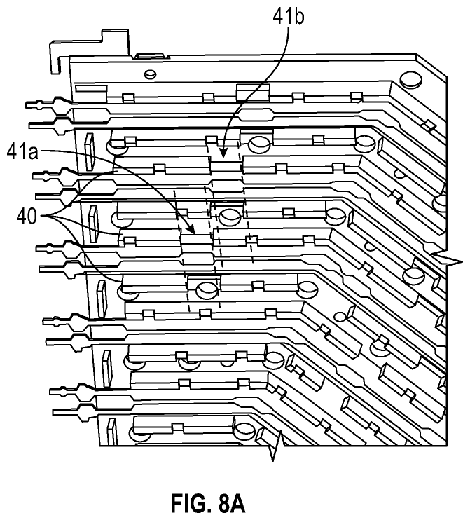

To further reduce the effects of unwanted, deleterious signals (e.g., crosstalk or more generally noise) each of the one or more first wafers 10a to 10i may be configured offset from a neighboring wafer 10a to 10i within the first wafer set 10. Further, the respective terminals and corresponding shields 11 of one wafer may be offset from a neighboring wafer. For example, referring now to FIG. 7 there is depicted a wafer set 10 (which may be a first wafer set) with two neighboring wafers 10a, 10b within the wafer set 10. Further, one set of contacts 23a is labeled for wafer 10a and one set of contacts 23b is labeled for wafer 10b though it should be understood that each wafer may include a plurality of sets of contacts (see FIG. 8, where wafer 10n includes a plurality of sets of terminals 14n and contacts 23—the contacts being occluded). In an embodiment, contacts 23a may be received by fingers 13a in FIG. 6 while contacts 23b may be received by fingers 13b.

In addition to reducing crosstalk, the offset wafers allow for repositioning of adjacent channels from one wafer to another. Because the sections of a wafer at the positions of channels may be subject to a high-level of potentially deleterious, electromagnetic signals, it may be desirable to adjust the positions of the channels to reduce such signals.

Yet further, offsetting the position of the wafers allows the connector assemblies 2, 3 to connect or mate appropriately. For example, an exemplary wafer offset at a mating interface may be a half pitch (2 mm) of the general pair-to-pair pitch within a wafer structure (which could be 4 mm) and/or equal to the wafer-to-wafer pitch (which could be 2 mm). Naturally, the desired pitch will vary depending on competing density and signal integrity demands of the connector system.

As shown in FIG. 7, contacts 23a and 23b of neighboring first wafers 10a, 10b are not aligned next to one another. Instead, they are offset from one another. Thus, high-speed, differential data signals being transported by terminals within wafer 10a may be protected from deleterious, electromagnetic effects caused by the transport of high-speed, differential data signals by terminals within wafer 10b (e.g., contacts 23b) and vice-versa, due to the offset configuration of the wafers 10a. 10b and their respective contacts as well as the protection provided by respective shields 11a, 11b.

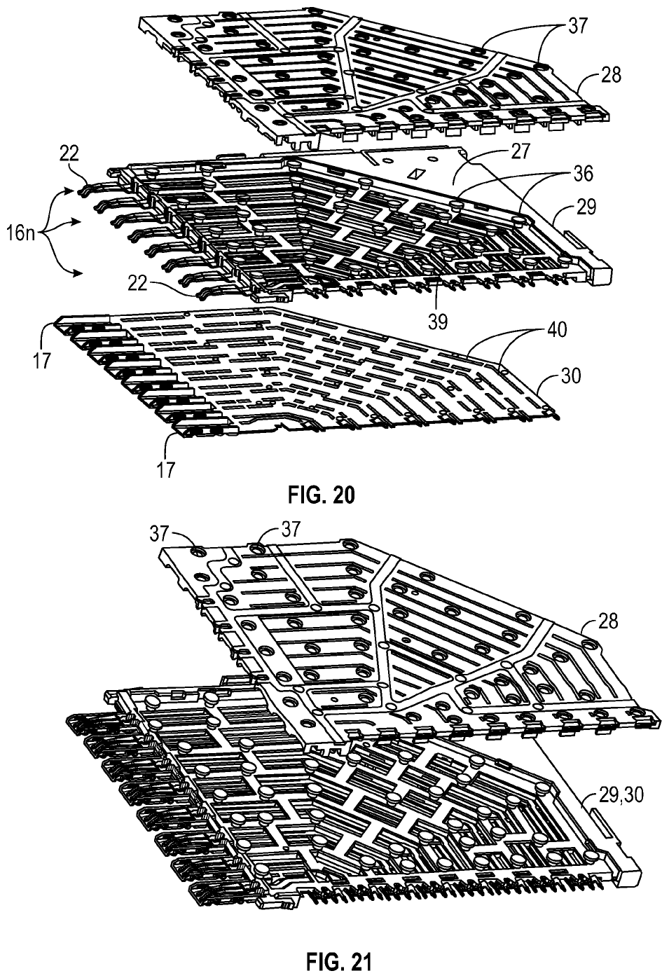

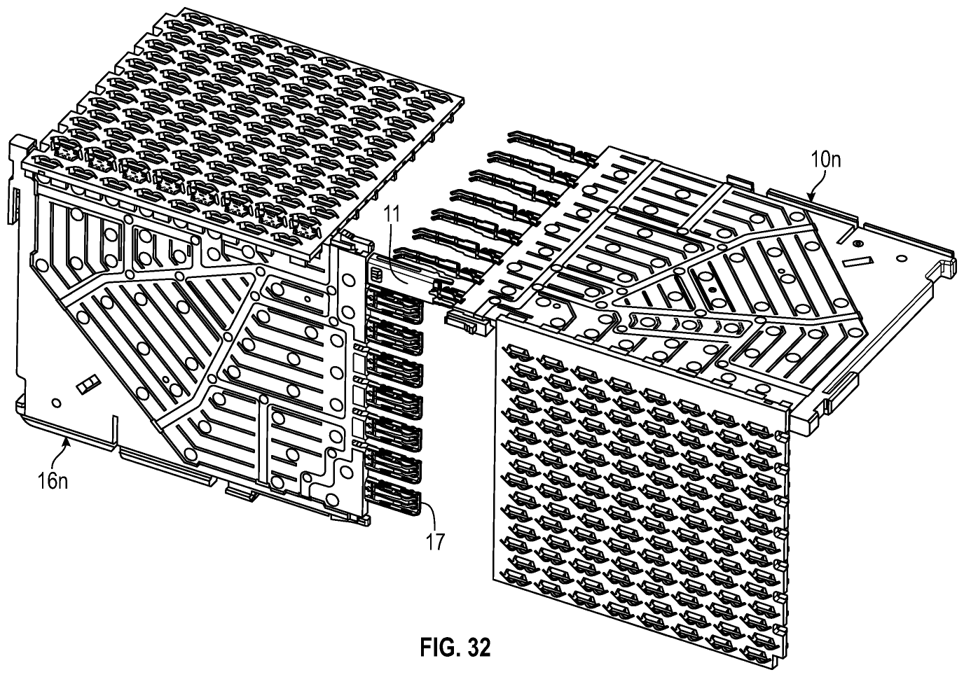

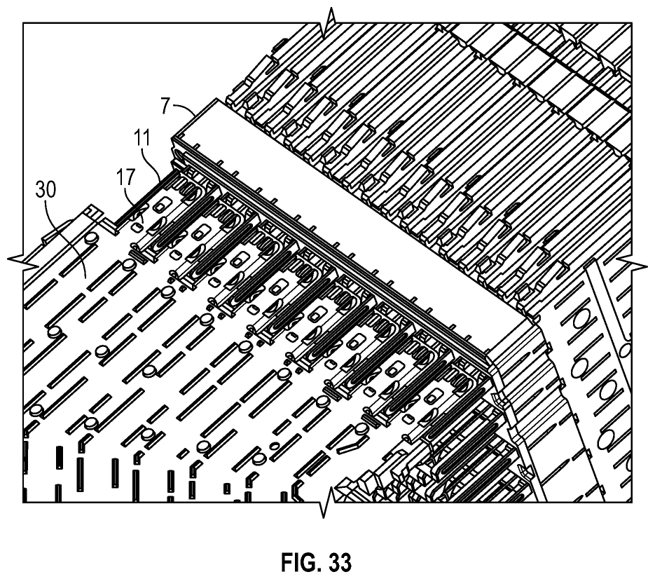

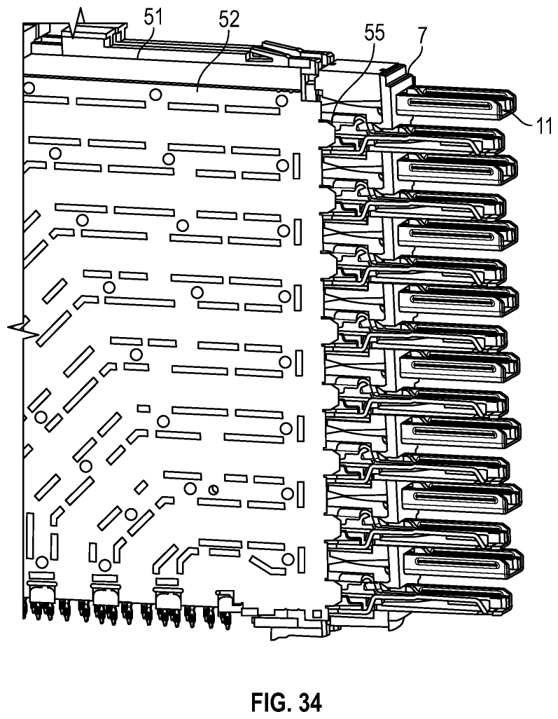

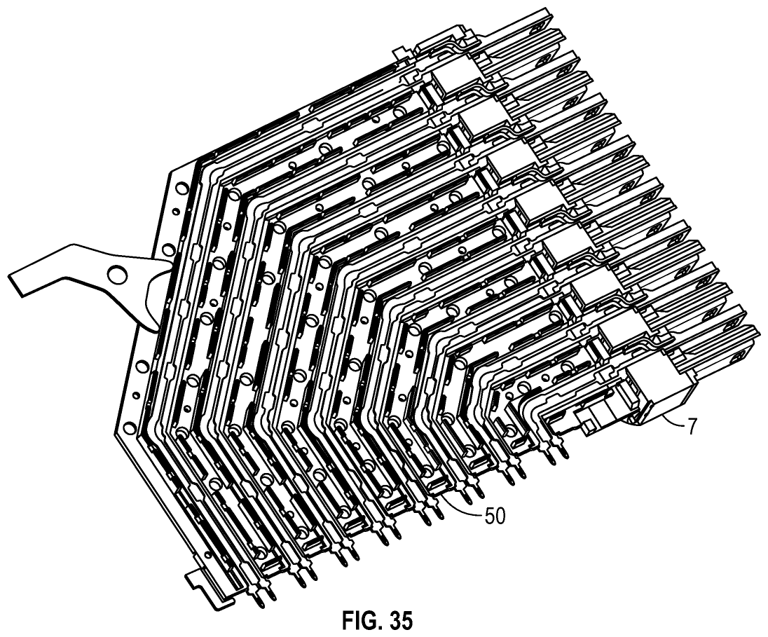

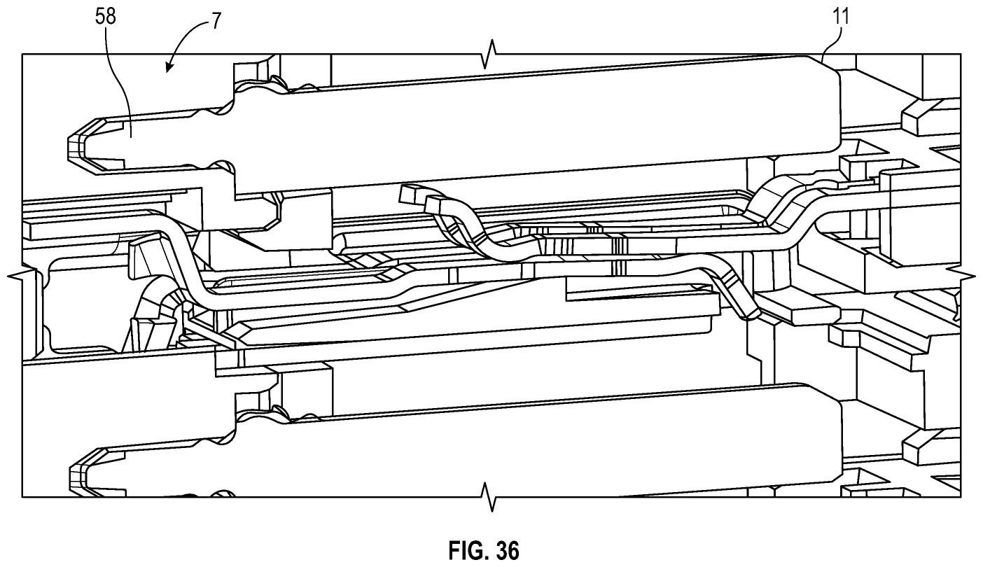

FIG. 8 depicts portions of an exemplary first wafer 10n with the frame and shield wafer omitted so as to better see the channel 38. The general structure of first wafer 10n is a cover 50, a wafer body 51 and a wafer shield 52 (see FIGS. 32-36) that form a three layer structure but the wafer shield 52 for the first wafer 10n does not include a U-shaped shield. Instead the wafer shield 52 includes an insert projection 55 that engages the insert 7. The shield 11a, for example, includes shield fingers 58 that engage the insert 7 as well. The insert has a conductive path between the insert projection 55 and the shield fingers 58 that provides for a ground connection therebetween. In comparison, as can be appreciated from FIG. 20 and as discussed below, the second wafer can comprise a cover 28, a wafer body 29 and a wafer shield 30 and thus has a similar construction to the first wafer but the wafer shield 30 includes shields 17 that are integrally formed in the wafer shield 30. The cover 28 can include openings 37 that engage projections 36 in a frame of the wafer body 29. The frame (not shown in FIG. 8) can be composed of an insulative material (such as an engineering grade plastic), and the frame may include a plurality of webs (such as webs 39 as shown in FIG. 20) that support terminals 14. In embodiments, the dimensions of each web where the frame supports the terminals and may be configured to reduce cross talk between adjacent sets of conductors. For example, a width of a conductor and/or a gap between conductors may be adjusted (e.g., by 40 to 60%) in order to compensate for changes in the dielectric properties when the web is replaced by air to maintain a more uniform impedance.

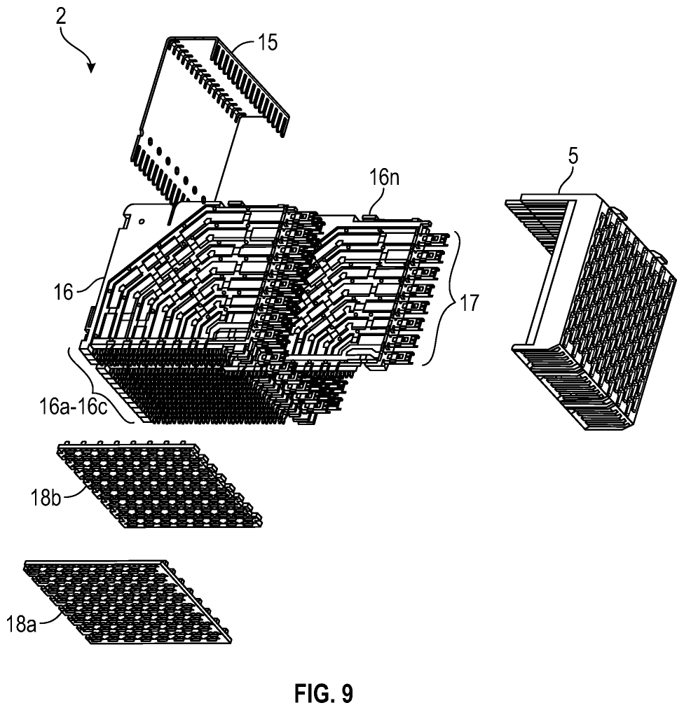

FIG. 9 illustrates an exploded view of the second connector assembly 2. As shown, connector assembly 2 may include, among other components, the second housing 5, a second retaining member 15, second tail alignment structures 18a, 18b and a second wafer set 16. In embodiments, the wafer set 16 may include one or more second wafers 16a to 16i (where “i” indicates a last wafer) that may be aligned and separated by retaining member 15, which as depicted is J shaped and engages the wafer set 16 in at least two locations. In this view one such second wafer 16n of the plurality of wafers is illustrated as being inserted into the second wafer set 16 (where “n” refers to one of the wafers within set 16).

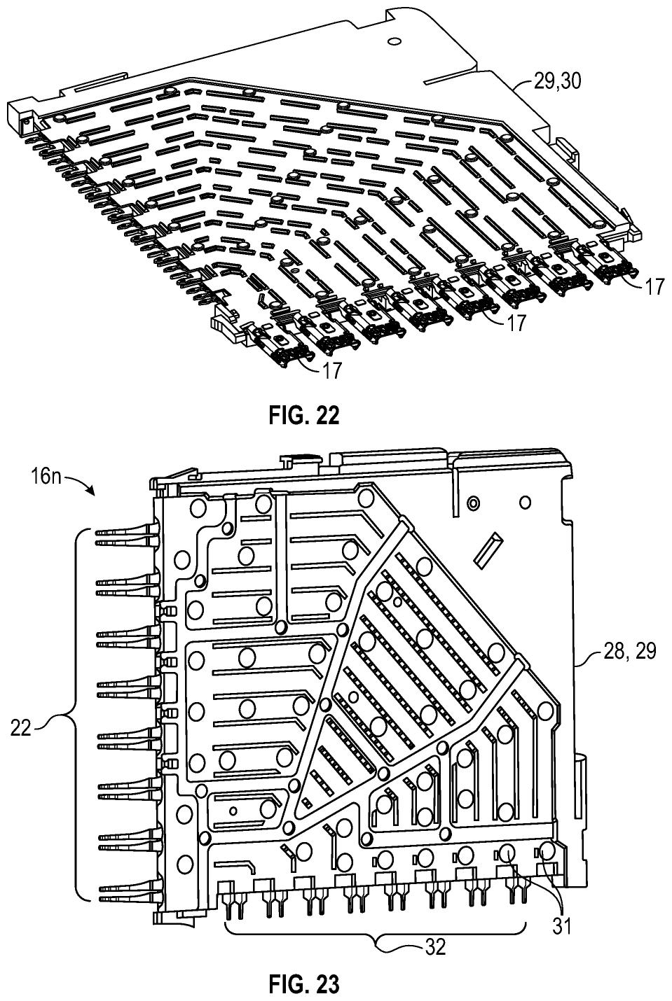

Referring now to FIGS. 20 to 22 there are depicted details of a respective second wafer 16n. In more detail, FIG. 20 depicts an exploded view of a second wafer 16n comprising a wafer body 29 composed of an insulative material that supports terminals 9 that include contacts 22, a wafer shield 30 that includes a plurality of integral second shields 17 (which as depicted are U-shaped) on a first side of the wafer body 29 and a cover 28 on a second side of the wafer body 29. It should be noted that additional wafers of wafer set 10 of connector assembly 3 may include similar features and construction. As shown in FIGS. 20 and 21 the wafer body 29 may have its frame 27 configured with one or more connective structures 36 on each of its sides (shown as circular pegs but not so limited); only one side of frame 27 is shown though both sides may have the connective structures 36 that may be shaped to be inserted into correspondingly shaped openings 37 in cover 28 and in openings 40 in wafer shield 30 to secure the cover and the plane to the wafer body, and vice-versa.

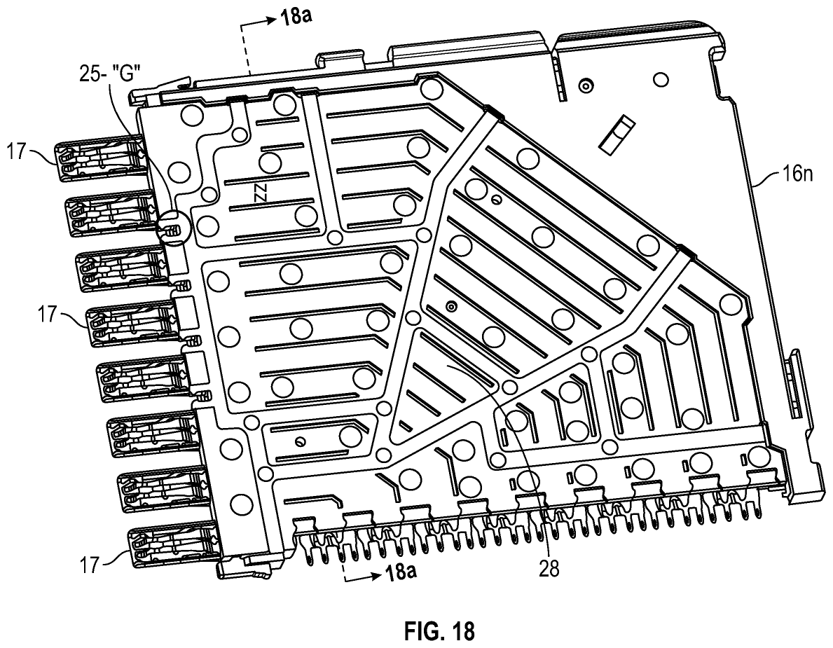

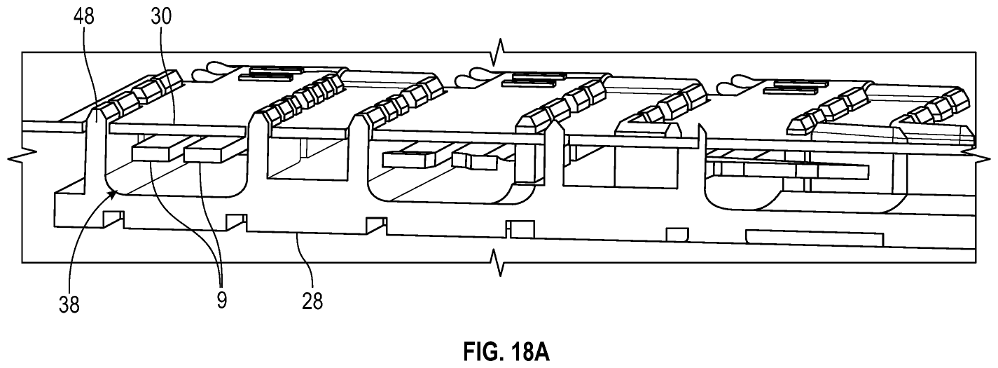

Further, as can be appreciated from the combination of FIGS. 18, 18a and 20, the wafer shield, the wafer body 29 and the cover 28 may be configured and shaped to ensure the terminals 9 are positioned within channels 38 by using webs 39 of the frame 29. Similar to above-described embodiments, the dimensions of each web 39 and the respective terminals may be configured to reduce cross talk between adjacent channels 38. For example, a width of a terminal and/or a gap between terminals may be adjusted (e.g., by 40 to 60%) in order to compensate for changes in the dielectric properties where the web is replaced by air to maintain a uniform impedance. Preferably, to reduce loss, the web is intermittently used to support the terminals 9 so that the effective dielectric constant is closer to the dielectric constant of air.

As can be appreciated from FIG. 8A, which is an enlarged view of FIG. 8, the channels 38 are formed in part by walls 48 of the cover 50.

In embodiments, each second wafer of the second wafer set 16 (e.g., wafer 16n) may support one or more terminals that transmit and receive high-speed, differential data signals (e.g., at least up to 112 Gbps). Terminals may be electromagnetically shielded as described more fully herein by second U-shaped, electromagnetic shields 17 that may be configured as second parts of a terminal enclosure.

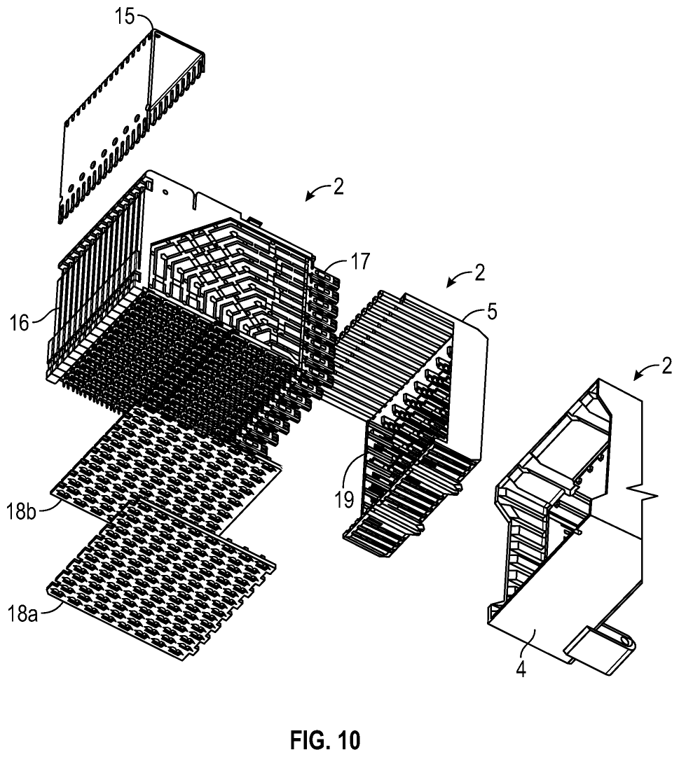

FIG. 10 depicts another exploded view of the second connector assembly 2. In this view exemplary second housing 5 is shown including support structure 19. As explained in more detail elsewhere herein, structure 19 may support and align terminal enclosures formed by the connection of first U-shaped shields 11 of assembly 3 and second U-shaped shields 17 of assembly 2.

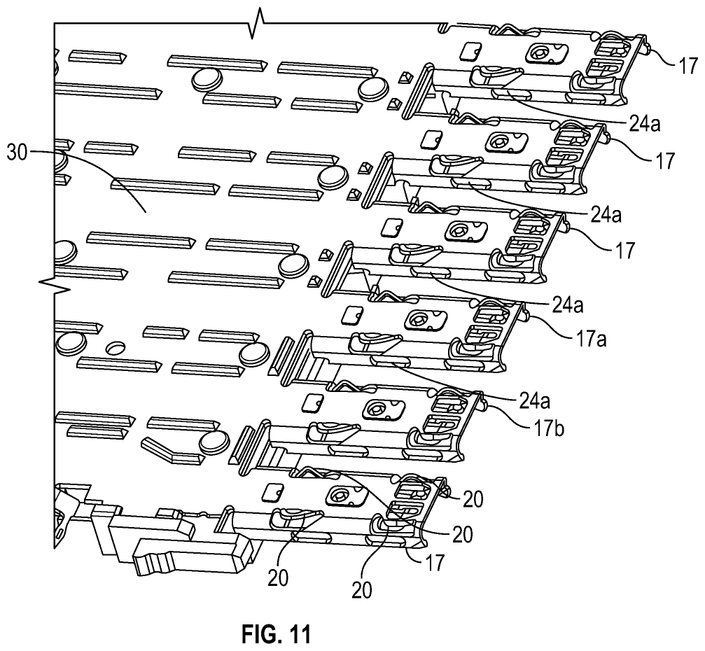

Referring now to FIG. 11 there is illustrated a plurality of second, integral U-shaped shields 17 that form second parts of terminal enclosures. The shields 17 may be formed as integral portions of the electrically grounded plane 30 of a wafer. In embodiments, each second wafer within second wafer set 16 may include its own plane 30 and a plurality of second, integral U-shaped shields 17.

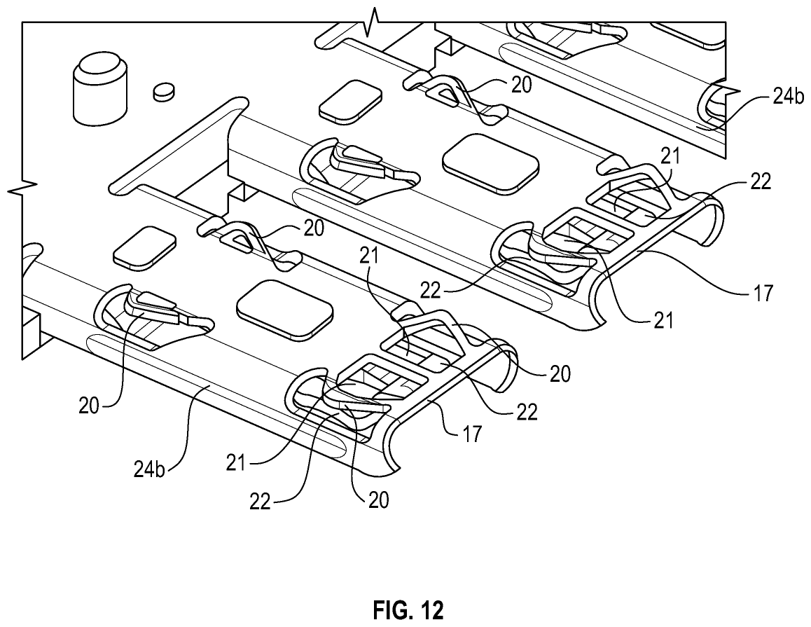

Each second shield 17 may include respective, exemplary protrusions 24a on shield sidewalls. It should be understood that each shield 17 includes two opposing sidewalls, where each opposing sidewall may include respective protrusions 24a, respectively, though only protrusions are shown on one opposing sidewall of each shield in FIG. 11. In FIG. 11, two such protrusions 24a are shown though this is merely exemplary. More or fewer protrusions may also be used (e.g., see for example, the single protrusion 24b in FIG. 12). Second shields 17 and their respective protrusions 24a may form one part of a terminal enclosure (a “second” part) that reduces the deleterious effects of unwanted electromagnetic signals from high-speed data signals being transported by terminals within each terminal enclosure. For example, two of shields 17 have been illustratively labeled 17a, 17b. Accordingly, high-speed, differential data signals being transported by terminals within one second shield 17a (see contacts 22 in FIG. 12) may be electromagnetically shielded from the deleterious effects of electromagnetic crosstalk generated by high-speed, differential data signals being transported by terminals within another second shield 17b, and vice-versa.

Referring to FIG. 12 there is shown an enlarged view of some second shields 17. As shown, each shield 17 may include openings 21 in a wall that is perpendicular to sidewalls, for example (e.g., either a top or bottom wall depending on the orientation of the assembly or wafer). Each opening 21 may be configured to be aligned with one or more of the contacts 22 of a second wafer that is transmitting and receiving a differential, high-speed data signal, for example. The ability to receive a contact 22 within an opening 21 reduces the chance that a contact 22 may inadvertently contact the ground shield 17 and thus result in a potential loss of data or signaling errors.

As noted previously, the second shields 17 may be formed as integral portions of an electrically grounded plane 30. FIGS. 11 and 12 also depict one or more (a plurality) integral, grounding “wings” 20. As shown and explained in more detail elsewhere herein, in embodiments each of the one or more wings 20 of a shield 17 of the second connector assembly 2 may be configured to contact a shield 11 of the first connector assembly 3 to form a ground path that includes both assemblies 2, 3. Because there are multiple shields 11, 17 within respective assemblies 2, 3 the plurality of wings 20 for each shield 17 form a plurality of ground paths between, and including, assemblies 2, 3. The inventors believe that the formation of a plurality of ground paths increases the likelihood that any unwanted, deleterious electromagnetic signals may be conducted away from terminals received within each shield 11,17 by the plurality of ground paths. Further, to reliably transport high-speed data signals it is important to maintain a consistent electrical ground. Thus, the formation of multiple redundant ground structures that form multiple, redundant ground paths helps insure a consistent electrical ground within system 1.

Though each second shield 17 is depicted as including four grounding wings 20 this is merely exemplary. More or fewer wings may be included provided the number of wings and their positioning forms similar ground paths and allows the wafers of the assemblies 2, 3 to be aligned in an offset pattern as described elsewhere herein.

Each of the second shields 17 may be configured as a second part of a terminal enclosure (e.g., a top, bottom or one side depending on the orientation of the terminal enclosure). In embodiments, when a shield 17 of assembly 2 (a second part) is combined with a shield 11 of assembly 3 (a first part) a terminal enclosure may be formed.

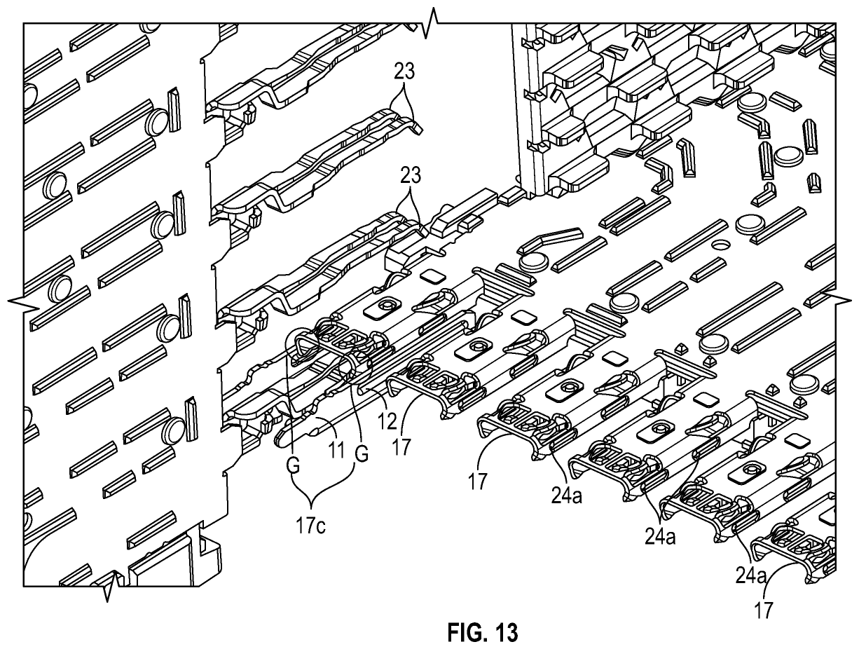

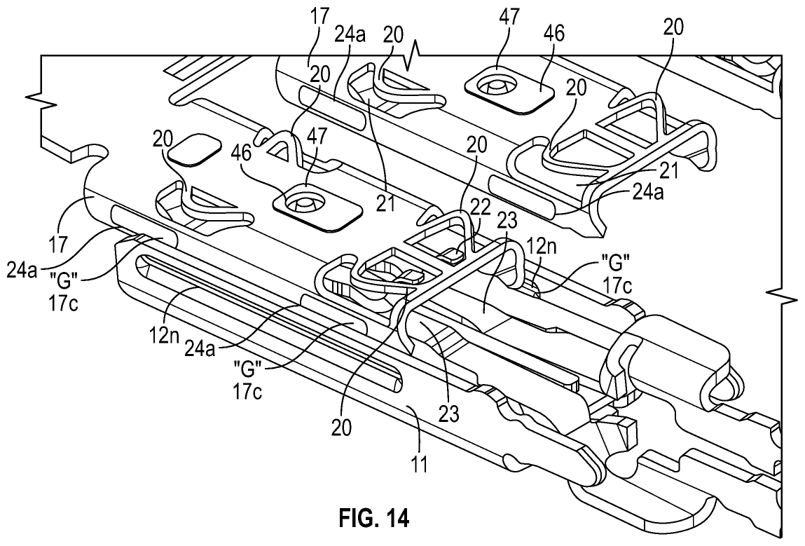

By way of example, the reader now is referred to FIGS. 13 and 14. In FIG. 13, an exemplary second shield 17 is shown connected to an exemplary first shield 11 to form an exemplary terminal enclosure. FIG. 14 depicts an enlarged view of such a connection and terminal enclosure.

In more detail, and as seen in FIG. 14, in an embodiment a first shield 11 that is electromagnetically shielding contacts 23 of a first wafer 10n of assembly 3 has been connected to a second shield 17 that is electromagnetically shielding contacts 22 of a second wafer 16n of assembly 2. In an embodiment, to make such an exemplary connection each sidewall of a shield 17 comprises one or more second protrusions 24a (or 24b) that may be configured to engage one or more first protrusions 12 (or 12n) of one of the one or more first shields 11 to form a terminal enclosure and to form an electrical ground path that includes the one or more first protrusions and one or more second protrusions. To aid the reader, exemplary points of connection between an exemplary first protrusion 12,12n and exemplary second protrusion 24a are labeled 17c or “G” in FIGS. 13,14 to denote that each connection forms a ground path between the so connected shields 11, 17.

The formation of shielded region by combining exemplary shields 11, 17 is believed to reduce the deleterious effects from unwanted electromagnetic signals on high-speed, differential data signals being transported by terminals within the contact interface, which normally is challenging to shield. For example, high-speed data signals being transported between terminals within one terminal enclosure formed by one set of shields 11, 17 may be electromagnetically shielded from the deleterious effects of noise generated by high-speed data signals being transported between terminals within another set of shields 11, 17, and vice-versa.

Though the description above describes the shields 11, 17 as having protrusions, this is merely exemplary. That is to say, instead of protrusions, either the first shield 11 or second shield 17 may include one or more indentations while either the second shield 17 or first shield may include one or more protrusions.

Collectively, it can be said that the discussion thus far has described a backplane connector system 1 that may comprise a first connector assembly 3 comprising a first housing 4 and a first wafer set 10 where the first wafer set 10 may comprise one or more first wafers 10a to 10i and where each first wafer is connected to one or more first shields 11 via a conductive path in an insert. Each first shield 11 may be configured as a first part of a terminal enclosure to protect high-speed, differential data signals from deleterious electromagnetic signals. In addition, such a system as thus far described may include a second connector assembly 2 comprising a second housing 5 that may be configured to connect to the first housing 4 to provide a plurality of electrical ground paths between the first and second assemblies discussed herein, and a second wafer set 16. In embodiments, the second wafer set 16 may comprise one or more second wafers 16a to 16i where each second wafer may comprise an electrically grounded plane comprising one or more integral, second shields 17. Further, each second shield may be configured as a second part of the terminal enclosure to protect the high-speed, differential data signals from deleterious electromagnetic signals.

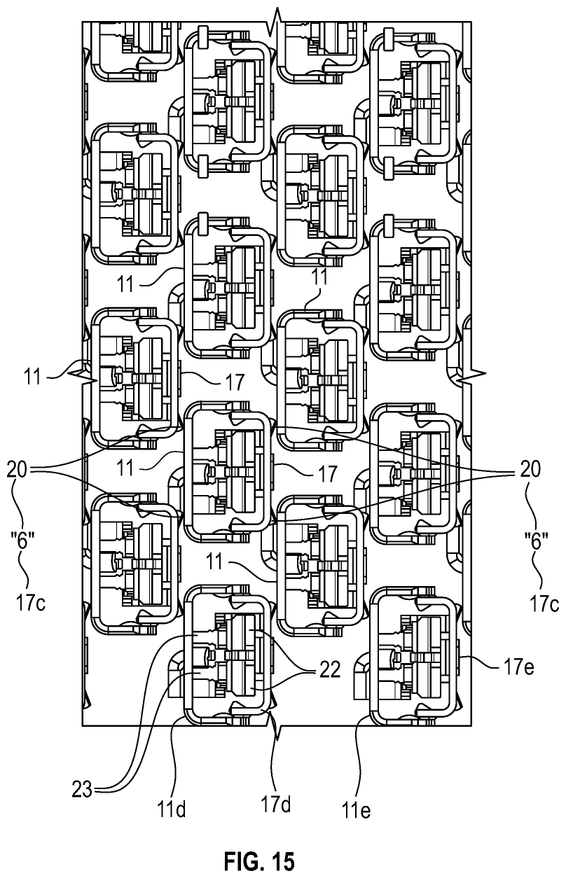

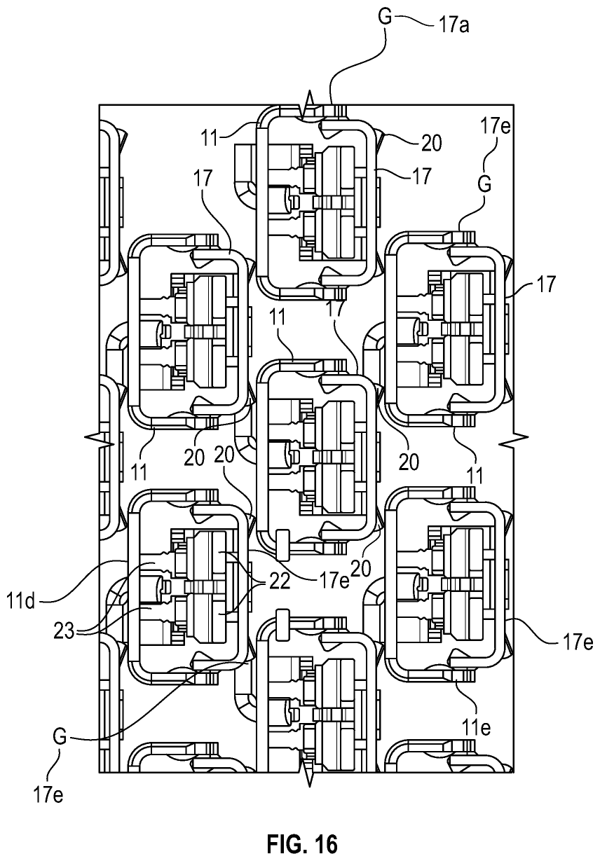

Continuing, as noted previously, to reduce the effects of unwanted, deleterious signals (e.g., crosstalk) the terminals within each shield and the corresponding shields 11, 17 may be offset. This is also true for the terminal enclosures formed by the connected shields. For example, referring now to FIGS. 15 and 16 there are depicted cross-sectional views of the formation of a pattern of offset terminal enclosures formed by the connection of shields 11, 17 of assemblies, 2, 3 (FIG. 16 illustrates an enlarged view of the pattern of offset, terminal enclosures).

As shown the terminal enclosures form a pattern of offset, terminal enclosures, where each terminal enclosure is configured as a set of respective shields 11, 17 that form one or more electrical ground paths, where each terminal enclosure is not aligned next to a neighboring, terminal enclosure formed by another set of shields 11, 17. Instead, they are offset from one another. For example, in FIGS. 15 and 16 two terminal enclosures are labeled as being formed by respective shields 11d, 17d and 11e, 17e. Thus, the terminal enclosure formed by the set of shields 11d, 17d is not aligned next to the terminal enclosure formed by the set of shields 11e, 17e. Rather, the terminal enclosures are offset from one another. Accordingly, the high-speed, differential data signals being transported by contacts 22, 23 within each cage of a wafer may be protected from deleterious, electromagnetic effects caused by the transport of high-speed, differential data signals by terminals within another wafer and vice-versa.

FIGS. 15 and 16 also depict the plurality of ground paths formed by the connection of wings 20 of a shield 17 of the second connector assembly 2 to a shield 11 of the first connector assembly 3. For example, exemplary points labeled 17c or “G” form some of the plurality of ground paths (the other connection points have not been labeled but are evident from the figure). The formation of a plurality of ground paths by a plurality of terminal enclosures increases the likelihood that any unwanted, deleterious electromagnetic signals may be conducted away from terminals within each terminal enclosure formed by respective shields 11, 17 by such ground paths.

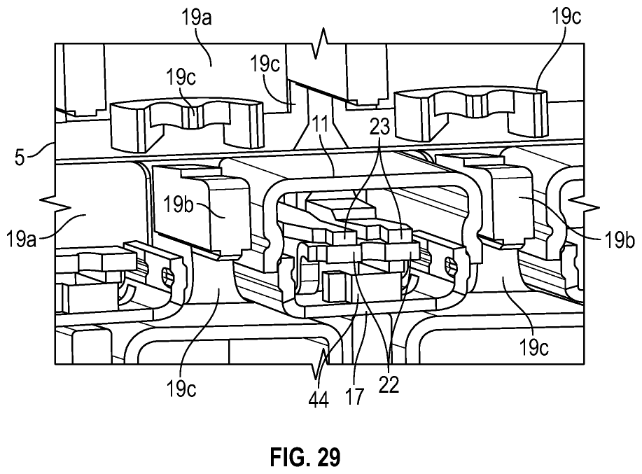

Referring now to FIG. 29 there is depicted an enlarged view of a terminal enclosure formed by a first shield 11 and a second shield 17 (both shields may also be referred to as U-shields). As shown each terminal enclosure may be supported and aligned by a support structure 19 of housing 5 (see FIG. 10). In embodiments, structure 19 may comprise one or more openings 19a, one or more separating ribs 19b and one or more tower foundations 19c (“foundation” for short). It should be understood that while only a single terminal enclosure is depicted in FIG. 29, that a plurality of electromagnetic shielded terminal enclosure (e.g., terminal enclosures) may be formed as a part of connector system 1. In embodiments, each opening 19a may be configured to receive a set of shields comprising one of the one or more first shields 11 and one of the one or more second shields 17 and their respective contacts 22, 23. Once received, the set of shields that makes up a terminal enclosure may be supported by one of the one or more, respective foundations 19c. Further, each of the one or more separating ribs 19b may be configured to help maintain the alignment of, and separation of, one set of shields from another set of shields, for example. By maintaining a separation between each terminal enclosure the deleterious effects of electrical crosstalk and other unwanted electrical interferences may be reduced.

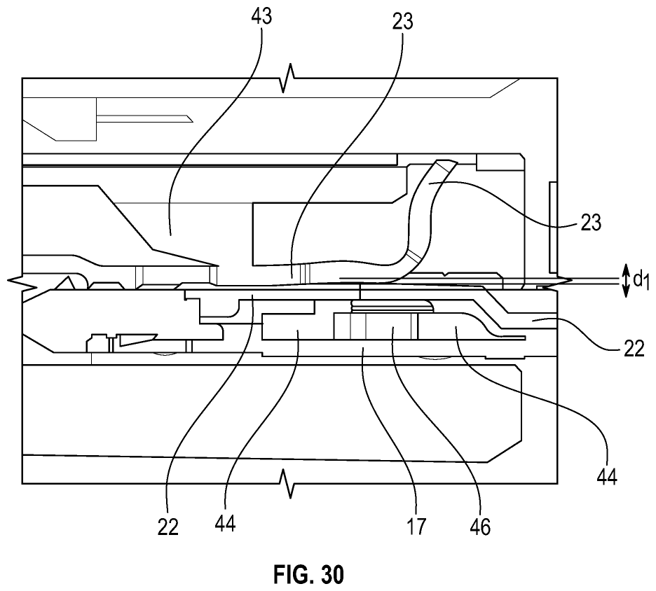

As shown in FIG. 29 the contacts 22 of a wafer from assembly 2 may be connected to the contacts 23 of assembly 3 within the terminal enclosure formed by shields 11, 17. In this figure only the ends of each respective contact 22, 23 are shown. Referring now to FIG. 30 there is depicted a side view of the terminal enclosure formed by shields 11, 17. In this view the shield 11 may include a first terminal support structure 45 and the shield 17 may include a second terminal support structure 44. In embodiments each of the respective support structures 44, 45 may be configured at a position within a respective shield 11,17 such that a respective support structure functions as a fulcrum to support an end of a respective contact 22,23 as each end is inserted into an opening 19a and supported by structure 19c. For example, second support structure 44 may be configured at a position within shield 17 such that the structure 44 functions as a fulcrum to support an end of a respective contact 22. Structure 45 may function similarly to support the end of terminal 23.

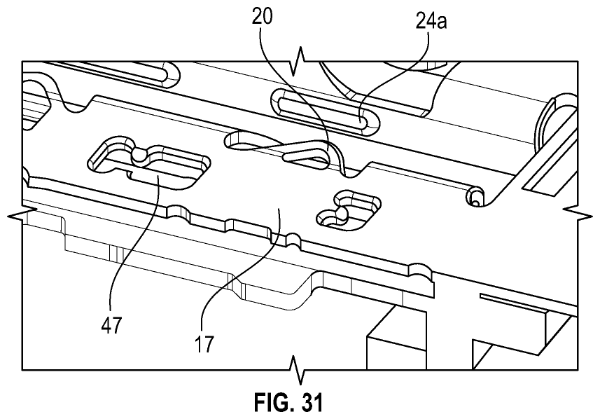

In an embodiment, each exemplary, second terminal support structure 44 of each may include an integral extension 46 that may be shaped to protrude through an correspondingly shaped opening 47 in a shield 17 to connect the support structure 44 to the shield 17 (see FIG. 31; see also FIG. 14 for an exemplary location of the extension 46).

FIG. 30 also indicates a gap di between contacts 22, 23 of an exemplary terminal enclosure that separates the two points of contact that are formed therebetween. In embodiments, the dimensions of at least the contacts 22, 23 and support structures 44, 45 may be configured such that the dimensions of this this gap may not exceed thresholds that may cause high-speed electrical signals being transported from contact 22 to terminal 23 (or vice-versa) to be lost or distorted.

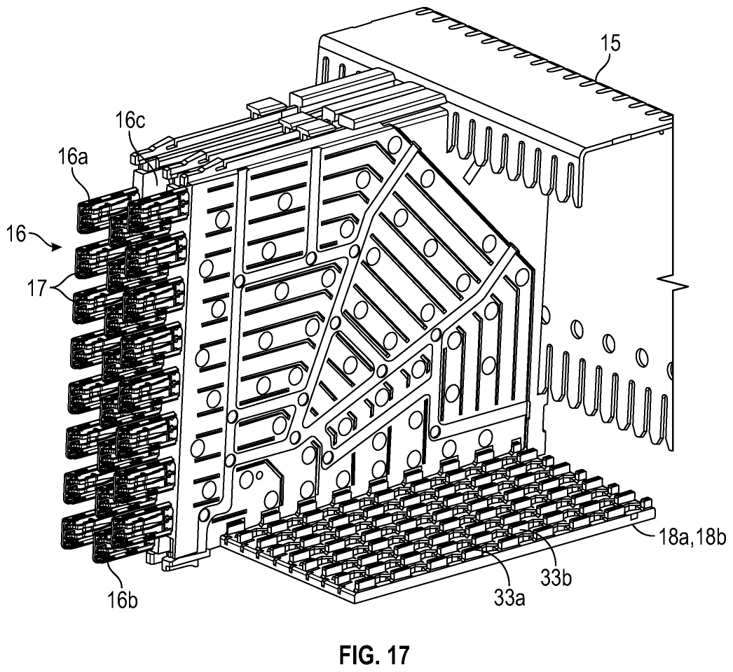

Referring now to FIG. 17, there is illustrated an additional view that depicts some of the wafers 16a, 16b, 16c of wafer set 16, where each wafer 16a, 16b, 16c may be offset from a neighboring wafer (e.g., wafer 16b is offset from neighboring wafers 16a, 16c). FIG. 17 also depicts exemplary, second tail alignment structures 18a, 18b and wafer alignment structure 15. In an embodiment, structures 18a, 18b include a plurality of retention tabs respectively, formed in rows that project towards a wafer. In FIG. 17 two of the exemplary tabs have been labeled 33a, 33b, where tab 33a is included in one row and tab 33b is included in another offset row of tabs. In embodiments, each wafer may be separated by a row of tabs, where a row of retention tabs aids in locking the position of each individual wafer within the wafer set 16.

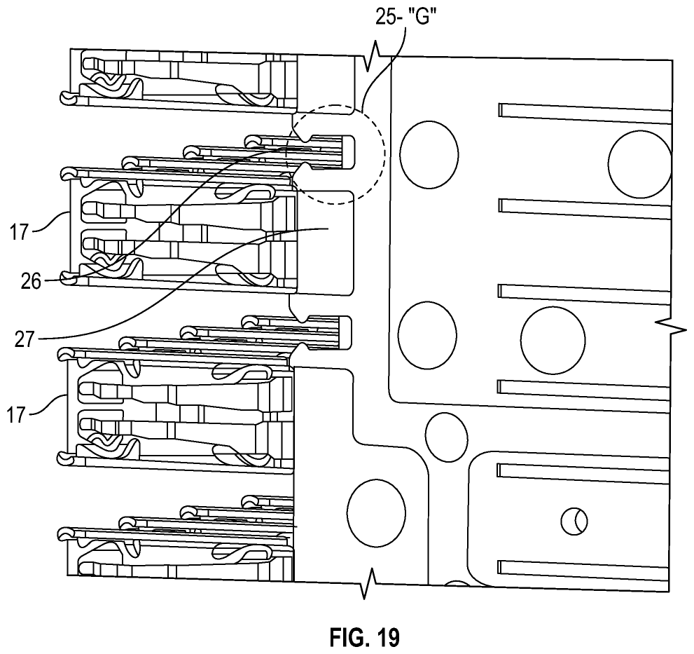

Referring now to FIGS. 18 and 19 there is depicted the connection of second shields 17 of a second wafer 16n of assembly 2 to an electrically grounded cover 28 of the wafer 16n at exemplary point 25 or “G”, where FIG. 19 illustrates an enlarged view of such a connection. In embodiments, an extension 26 of the shield 17 (each shield may include such an extension) may be connected to the ground cover 28 via a desired connection process (press fit, welding, etc.) to form a ground path between the shield 17 and the cover 28.

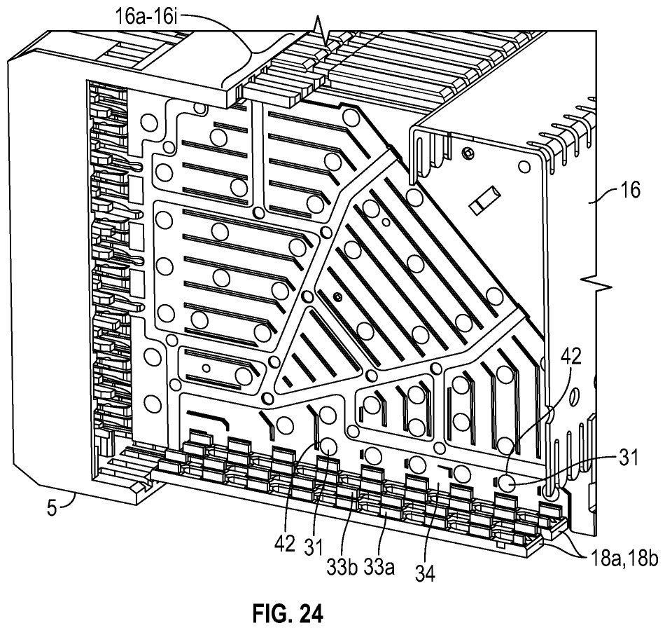

Referring now to FIG. 23 there is depicted a view of a wafer 16n without an electrically grounded plane 30 and shields 17 attached. As shown, wafer 16n may include a plurality of tails 32. In embodiments, it should be understood that each of the tails of each wafer of wafer set 16 (and wafer set 10) may be connected to the tail alignment structures 18a, 18b as shown in FIGS. 24 to 27. One or more shaped and raised protrusions 31 of the ground cover are also shown. These protrusions will aid in connecting the wafers (e.g., 16n) to the tail alignment structures thus each wafer may have its own raised protrusions.

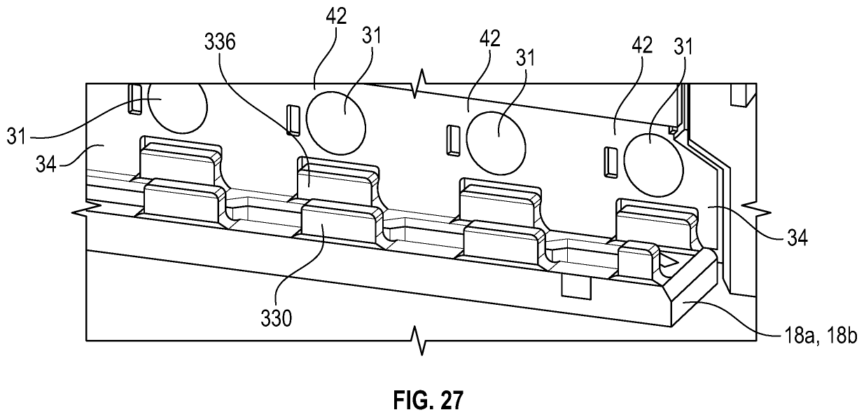

In more detail, FIG. 24 depicts the connection of offset wafers 16a to 16i of body 16 to an offset tail alignment structures 18a, 18b. Structure 18a, 18b may include a ridge portion 34 that includes a plurality of openings 42 (see also FIG. 27 that shows an enlarged view) where each opening 42 is configured to be shaped to receive a correspondingly shaped and raised protrusion 31 in order to connect a wafer to the structures 18a, 18b.

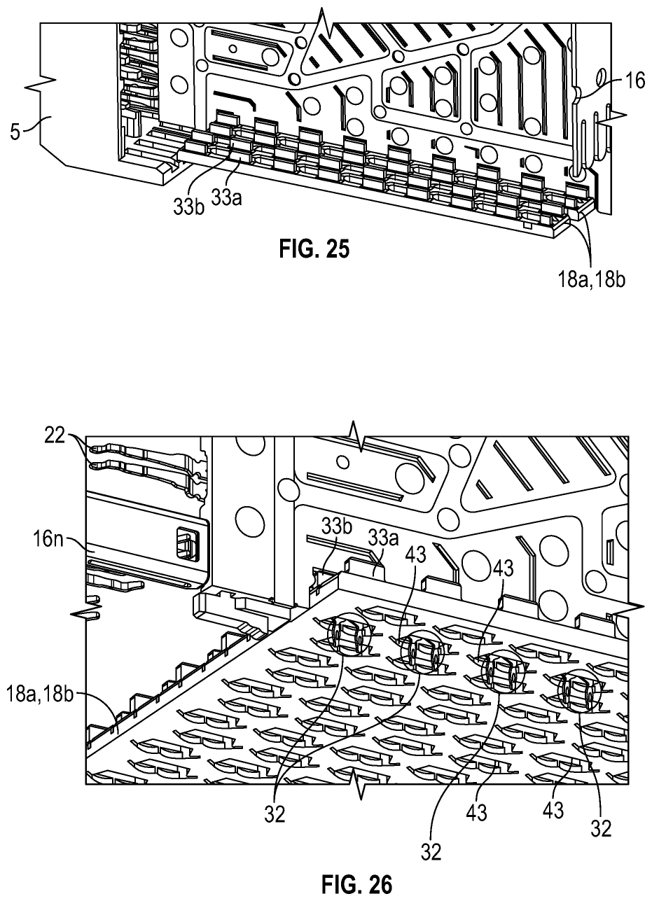

Both FIGS. 24 and 25 depict views of the connection of the offset wafers 16a to 16i to the offset tail alignment structures 18a, 18b. As indicated previously structures 18a, 18b may include a plurality of retention tabs respectively, formed in offset rows that project towards a wafer. Two exemplary tabs are labeled 33a, 33b, where tab 33a is included in one row and tab 33b is included in another, row. In embodiments, each wafer 16a to 16i may be separated by a row of tabs, where a row of retention tabs aids in locking the position of each individual wafer within the wafer set 16.

FIG. 26 illustrates a view of the connection of an offset wafer 16n to offset tail alignment structures 18a, 18b from underneath the assembly 1. In this view exemplary tails 32 of wafer 16n are shown connected to the structures 18a, 18n which may be composed of a conductive, plated plastic. In embodiments the structures 18a, 18b may be composed of a plated plastic and have a plurality of openings 43, where each opening 43 may be aligned with a set of protruding differential signals tails 32 of a wafer. Similarly, ground tails of each wafer may be connected to the structures 18a, 18b (not shown in figures). In embodiments, an air gap may be formed around each pair of differential signal tails 32 to help manage the impedance of the connected tails. Further, the presence of the air gap may also reduce the chances that small changes in the dimensions of the connected tails do to bending, etc., does not affect the impedance of the connection.

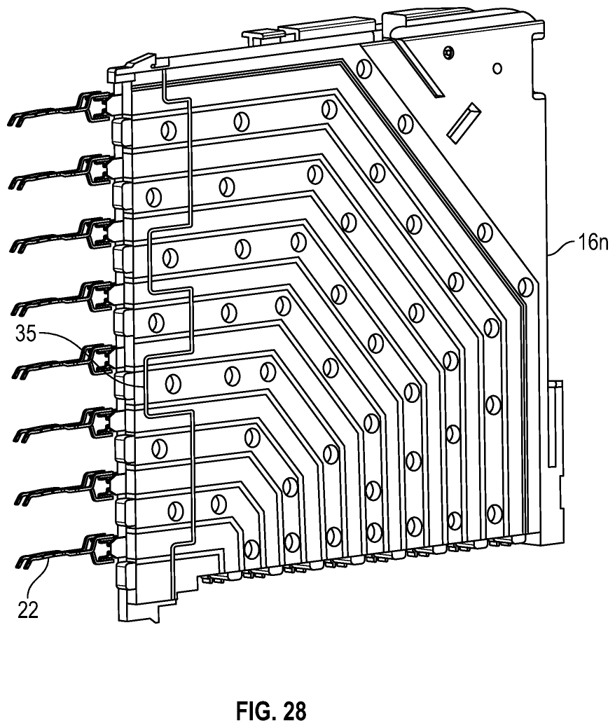

FIG. 28 depicts a view of an exemplary wafer gripper 35. In embodiments, the gripper 35 may comprise a plurality of openings (not shown) to accommodate pegs from a wafer frame of either assembly 2, 3. The rib gripper 35 may be configured to be connected to a wafer 16n (e.g., on to cover) such that the rib gripper extends from the top of the wafer to the bottom of the wafer in a staggered or zig-zag configuration. Alternatively, a rib gripper may extend diagonally and laterally towards edges of the wafer. A rib gripper may include one or more pairs of extensions extending towards a mating edge to grasp and keep a housing (not shown) in place. Yet further a rib gripper may also be connected to a ground insert.

While benefits, advantages, and solutions have been described above with regard to specific embodiments of the present invention, it should be understood that any component(s) that may cause or result in such benefits, advantages, or solutions to become more pronounced are not to be construed as a critical, required, or an essential feature or element of any or all the claims appended to the present disclosure or that result from the present disclosure.

Further, the disclosure provided herein describes features in terms of specific exemplary embodiments. However, numerous additional embodiments and modifications within the scope and spirit of the appended claims will occur to persons of ordinary skill in the art from a review of this disclosure and are intended to be covered by the disclosure and appended claims. Accordingly, it is intended that all such additional embodiments, modifications and equivalents of the subject matter recited in the claims appended hereto are included as permitted by applicable law. Moreover, any combination of the above-described components in all possible variations thereof is encompassed by the disclosure unless otherwise indicated herein or otherwise clearly contradicted by context.

We claim:

1. A backplane connector system comprising;
a first orthogonally positioned connector assembly comprising a first housing and a first wafer set,
wherein the first wafer set comprises a first wafer and the first wafer comprises a first set of terminals and a first wafer shield, the first wafer shield connected to a first shield via an insert, the first shield configured as a first part of a terminal enclosure; and
a second orthogonally positioned connector assembly comprising a second housing configured to connect to the first housing, and a second wafer set, wherein the second wafer set comprises a second wafer and the second wafer comprises a second pair of terminals and a second wafer shield with an integral second shield, the second shield configured to engage the first shield to form a second part of the terminal enclosure, wherein the first and second pair of terminals are configured to provide a differential signal path.

2. The system as in claim 1 wherein the differential signal path is configured to support high-speed data signals at 112 Gigabits per second.

3. The system as in claim 1 wherein the first assembly further comprises an electrical ground insert connected to each of the one or more first U-shaped shields of each first wafer to form an electrical ground path at each connection.

4. The system as in claim 1 wherein each of the one or more first U-shaped shields of each first wafer comprises opposing sidewalls, and each opposing sidewall comprises at least one first protrusion, each first protrusion configured to slidably contact one or more second protrusions from one of the one or more second U-shaped shields to form the terminal enclosure and to form an electrical ground path that includes the first and second protrusions.

5. The system as in claim 1 wherein each of the one or more first wafers are configured offset from a neighboring wafer within the first wafer set to reduce the effects of unwanted, deleterious electromagnetic signals.

6. The system as in claim 1 wherein the second housing further comprises a support structure to support and align at least the terminal enclosure.

7. The system as in claim 6 wherein the support structure comprises one or more openings, one or more separating ribs and one or more tower foundations.

8. The system as in claim 7 wherein one of the one or more openings is configured to receive a set of shields comprising one of the one or more first U-shaped shields and one of the one or more second U-shaped shields.

9. The system as in claim 8 wherein one of the one or more foundations supports the set of shields.

10. The system as in claim 8 wherein one of the one or more ribs is configured to maintain the alignment of, and separation of, the set of shields.

11. The system as in claim 1 wherein each of the first U-shaped shields comprises a first terminal support structure.

12. The system as in claim 11 wherein the first terminal support structure is configured at a position within the respective first U-shaped shield to function as a fulcrum to support an end of a respective terminal.

13. The system as in claim 1 wherein each of the second U-shaped shields comprises a second terminal support structure.

14. The system as in claim 13 wherein the second terminal support structure is configured at a position within the respective second U-shaped shield to function as a fulcrum to support an end of a respective terminal.

15. The system as in claim 1 wherein each of the one or more second U-shaped shields comprises opposing sidewalls, each sidewall comprising one or more second protrusions configured to slidably contact one or more first protrusions of one of the one or more first U-shaped shields to form the terminal enclosure and to form an electrical ground path that includes the first and second protrusions.

16. The system as in claim 1 wherein each of the one or more second U-shaped shields comprises one or more integral, grounding wings, each wing configured to contact one of the first U-shaped shields to form an electrical ground path.

17. The system as in claim 1 wherein each of the one or more second U-shaped shields comprise an extension connected to an electrical ground cover to form an electrical ground path between the shield and the cover.

18. A backplane connector system comprising;
a first orthogonally positioned connector assembly comprising a first housing and a first wafer set,
wherein the first wafer set comprises one or more first wafers and each first wafer comprises one or more first U-shaped shields, each first shield configured as a first part of a terminal enclosure to protect high-speed differential data signals from deleterious electromagnetic signals; and
a second orthogonally positioned connector assembly comprising a second housing configured to connect to the first housing to provide a plurality of electrical ground paths between the first and second assemblies, and a second wafer set,
wherein the second wafer set comprises one or more second wafers and each second wafer comprises an electrically grounded plane comprising one or more integral, second U-shaped shields, each second shield configured as a second part of the terminal enclosure to protect the high-speed differential data signals from deleterious electromagnetic signals.

19. The system as in claim 18 wherein:
each of the one or more first U-shaped shields of each first wafer comprises opposing sidewalls, and each opposing sidewall comprises at least one first protrusion, each first protrusion configured to slidably contact ne or more second protrusions from one of the one or more second U-shaped shields to form the terminal enclosure and to form at least one of the ground paths that includes the first and second protrusions, and
wherein each of the one or more second U-shaped shields comprises one or more integral, grounding wings, each wing configured to contact one of the first U-shaped shields to form at least a second one of the ground paths.

20. A backplane connector system comprising a pattern of offset terminal enclosures, where each terminal enclosure is configured as a set of U-shaped electromagnetic shields that form one or more electrical ground paths and wherein each terminal enclosure is not aligned next to a neighboring terminal enclosure formed by another set of U-shaped electromagnetic shields.
